(19) United States
(12) Patent Application Publication
(10) Pub. No.: US 2005/0094842 A1
(43) Pub. Date: May 5, 2005

(54) Speaker device and method for manufacturing the same

(76) Inventor: Kazuo Hashiba, Yamagata (JP)

Correspondence Address: YOUNG & THOMPSON, 745 SOUTH 23RD STREET, 2ND FLOOR, ARLINGTON, VA, 22202, US

(21) Appl. No.: 10/976,918

(22) Filed: Nov. 1, 2004

(30) Foreign Application Priority Data
Oct. 30, 2003 (JP) 2003-370682

(51) Int. Cl. H04R 1/02

(52) U.S. Cl. 381/389

(57) ABSTRACT

The speaker device includes a terminal electrically connected to an external circuit and a voice coil, and a frame for housing a speaker unit. The frame has a hooked protruding portion and a hole. The terminal has a contact point portion formed at one end and in contact with the external circuit, an insertion portion formed at the other end, a mounting portion mounted to a frame, and an opening formed at the mounting portion. At the time of manufacturing, the terminal is fixed to the frame by inserting the insertion portion formed at the terminal into the hole formed in the frame and inserting the hooked protruding portion formed at the frame into the opening formed at the terminal, and by relatively sliding the terminal and the frame to engage the inner peripheral edge portion of the opening with the hooked protruding portion. Since this speaker device has a simple construction in which the terminal is directly mounted on the frame, the manufacturing cost can be reduced by the amount of the board as in the conventional speaker device since the board is not provided, and the cost of the speaker device can be reduced.

### BACKGROUND OF THE INVENTION

1. Field of the Invention

The present invention relates to a speaker device which is loaded on an information equipment such as a cellular phone, and a method of manufacturing the same.

2. Description of Related Art

As reduction in size and cost of information equipments such as cellular phones and PDA (Personal Digital Assistants) has advanced in recent years, measures to reduce the cost and space are also required for the speaker devices constituting the information equipments. Such a speaker device is provided with a terminal in a spring form for electrically connecting a voice coil with a printed circuit board which is a constituent of the information equipment. An electrical signal outputted from the information equipment is supplied to the voice coil through the terminal in the spring form. This makes the diaphragm of the speaker device vibrate in its axial direction to perform sound reproduction.

As a speaker device of this kind, namely, the speaker device with the structure in which the terminal in the spring form is electrically connected to the voice coil and the printed circuit board of the information equipment, for example, the following speaker devices are known.

For example, there is known a speaker device having the structure in which a speaker unit including a terminal board is mounted to a protector which is formed integrally with a spring terminal by resin molding (for example, refer to the Japanese Patent Application Laid-Open under No. 10-224879). In this speaker device, an end portion of the spring terminal and a lead wire of the voice coil are respectively soldered to electrode portions of the terminal board, and thereby the spring terminal and the voice coil are electrically connected. Also, in the speaker device of this document, the spring terminal is fixed to an external terminal connecting portion of the terminal board by a caulking pin, and the external terminal connecting portion and the lead wire connecting portion are electrically connected.

There is known an electroacoustic transducer in which a spring terminal is joined to a printed board housed in the electroacoustic transducer by soldering (for example, refer to the Japanese Patent Application Laid-Open under No. 11-282473).

However, the above-described speaker device needs to be provided with a terminal board (or a printed board) to which a spring terminal is soldered, which causes the problem of increasing the product cost correspondingly.

Also, in the above-described speaker device in which the spring terminal and the terminal board are fixed to each other by the caulking pin, it is necessary to ensure a predetermined space around the caulking pin for insertion of a jig and the like for a caulking operation. Therefore, the contact point portions of a pair of spring terminals cannot be disposed around the caulking pin, and hence the contact point portions of the pair of spring terminals are disposed inside the frame. As a result, the contact point portions of the pair of spring terminals cannot be disposed close to each other. Namely, in such a speaker device, it is not possible to dispose the contact point portions of a pair of spring terminals close to each other and dispose the contact point portions at the positions of the outer peripheral edge portion of the speaker device, and therefore there arises the problem of being unable to cope with narrowing of the pitch of the patterns of a printed circuit board constituting an information equipment.

### SUMMARY OF THE INVENTION

As the problems to be solved by the present invention, those described above are cited as examples. The present invention has its object to provide a speaker device which copes with narrowing of a pitch of a pattern of a printed circuit board constituting an information equipment, and to which a terminal is capable of being mounted reliably at low cost, and a method of manufacturing the same.

According to one aspect of the present invention, there is provided a speaker device including a terminal electrically connected to an external circuit and a voice coil, and a frame for housing a speaker unit, wherein the frame has a hooked protruding portion and a hole, wherein the terminal has a contact point portion which is formed at one end and is in contact with the external circuit, an insertion portion formed at the other end, a mounting portion mounted to the frame, and an opening formed at the mounting portion; and wherein the terminal is fixed to the frame by the insertion portion being inserted into the hole and the hooked protruding portion engaging in an inner peripheral edge portion of the opening.

According to the above-described speaker device, an electrical signal outputted from the external circuit is supplied to the voice coil via the terminal and sound reproduction is performed. The terminal is preferably a spring terminal capable of being bent in a predetermined direction. This speaker device has a simple construction in which the terminal is directly mounted on the frame, and therefore the manufacturing cost can be reduced by the amount of the board as in the conventional speaker device, since the board is not provided. Therefore, the speaker device can be made less expensive.

It is preferable that the terminal is mounted to the frame in an outer peripheral edge portion of the frame. In one feature of the above-described speaker device, a pair of the terminals are fixed to the frame, and each of the contact point portions is disposed close to each other at positions on an outer peripheral edge of the frame.

In the conventional speaker device in which the spring terminal and the frame are fixed by the caulking pin, the caulking pin is pressed and crushed to fix the spring terminal and the frame after the spring terminal is mounted on the frame, and therefore it is necessary to ensure a predetermined space around the caulking pin. Therefore, the contact point portions of a pair of spring terminals cannot be disposed around the caulking pin, and the contact point portions of a pair of spring terminals cannot be brought into close vicinity to each other.

However, the above-described speaker device does not have the construction in which the spring terminal is mounted on the frame by the caulking pin, and therefore the contact point portions of a pair of terminals can be disposed at the positions at which they are close to each other and at the positions on the outer peripheral edge portion of the frame. Therefore, according to this speaker device, it is possible to cope with narrowing of a pitch of an external circuit, for example, a pattern of a printed circuit board constituting an information equipment.

In one feature of the above-described speaker device, the mounting portion is adhered to the frame by an adhesive element. As a result, the terminal can be reliably fixed to the frame.

According to another aspect of the present invention, there is provided a method of manufacturing a speaker device including a terminal electrically connected to an external circuit and a voice coil, and a frame for housing a speaker unit, the method including the step of fixing the terminal to the frame by inserting an insertion portion formed at the terminal into a hole formed in the frame and inserting a hooked protruding portion formed at the frame into an opening formed in the terminal, and by relatively sliding the terminal and the frame to engage an inner peripheral edge portion of the opening with the hooked protruding portion.

The method of manufacturing this speaker device has the simple construction in which the terminal is directly mounted on the frame, and therefore the manufacturing cost can be reduced by the cost of the board as in the conventional speaker unit since the board is not provided. Therefore, the speaker device can be made less expensive.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIGS. 1A and 1B are a plan view and a side view of a speaker device according to this embodiment;

FIGS. 2A, 2B, 2C and 2D are a front view, a rear view and a side view of a spring terminal, and a sectional view of a speaker unit;

FIG. 3 is a side view of spring terminals and a printed circuit board which are connected;

FIG. 4 is a flow chart of a method of manufacturing the speaker device;

FIGS. 5A and 5B are a plan view and a side view of components of the speaker device in a manufacturing process of the speaker device; and

FIG. 6 is a plan view of the components of the speaker device in the manufacturing process of the speaker device.

### DETAILED DESCRIPTION OF THE PREFERRED EMBODIMENTS

Hereinafter, a preferred embodiment of the present invention will be explained with reference to the drawings.

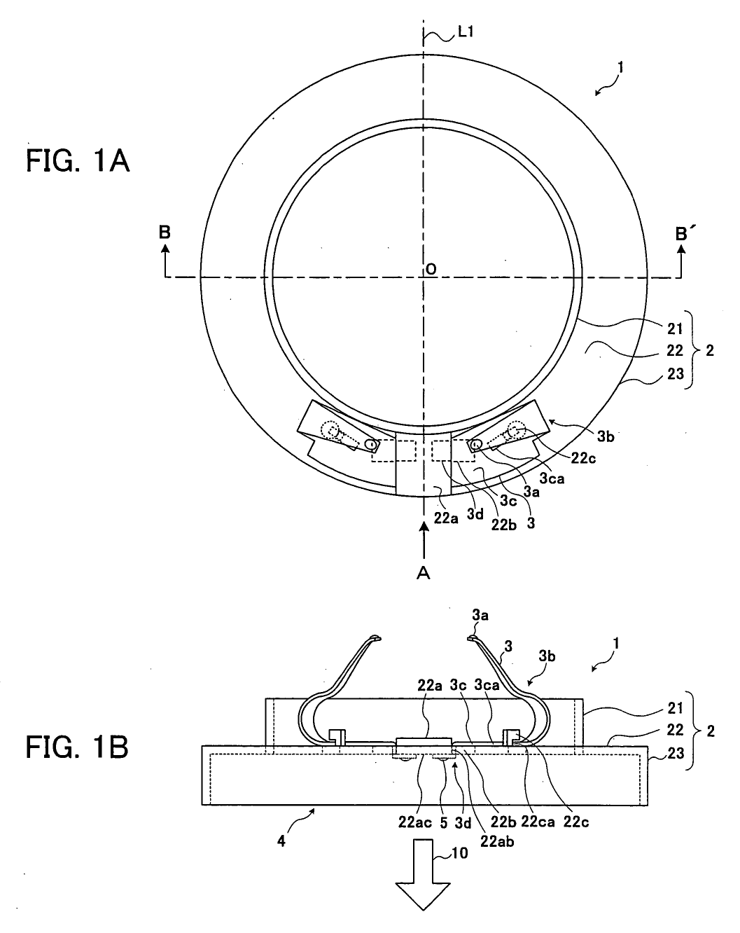

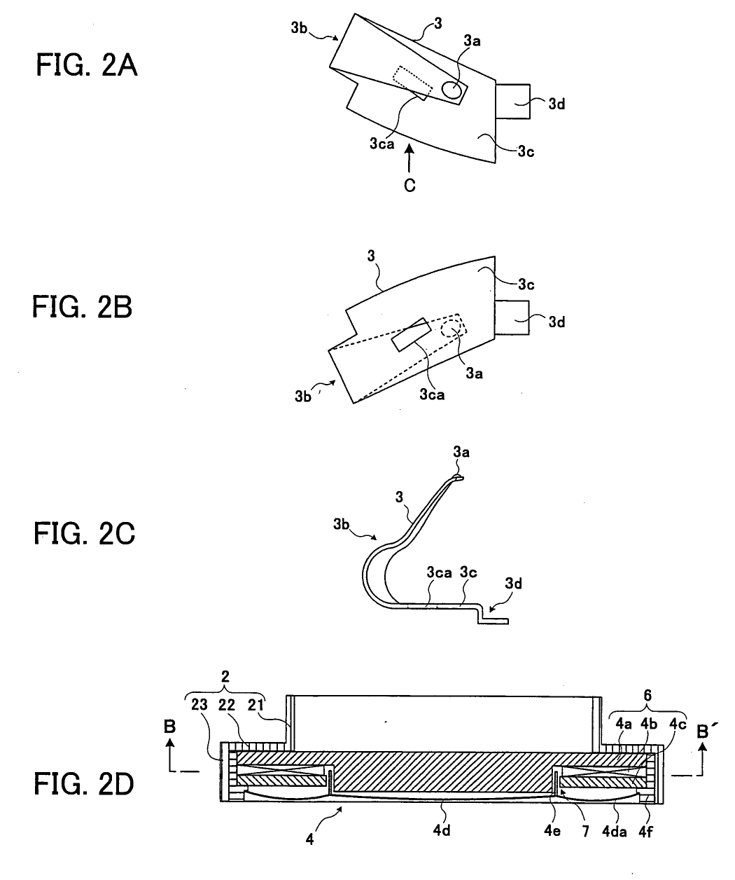

FIGS. 1A and 1B show a schematic diagram of a speaker device 1 according to an embodiment of the present invention. FIG. 1A shows a plan view of the speaker device 1, and FIG. 1B shows a side view when the speaker device 1 in FIG. 1A is observed from the direction of the arrow A. FIGS. 2A to 2C show a structure of a spring terminal 3 constituting the speaker device 1. FIG. 2A shows a front view of the spring terminal 3, FIG. 2B shows a rear view of the spring terminal 3, and FIG. 2C shows a side view when the spring terminal 3 in FIG. 2A is observed from the direction of the arrow C. Further, FIG. 2D shows a sectional view taken along the cutting-plane line B-B′ of the speaker device 1 in FIG. 1A. First, a configuration of the speaker device 1 according to the embodiment of the present invention will be explained with reference to FIGS. 1A and 1B, and FIGS. 2A, 2B, 2C and 2D.

The speaker device 1 includes a frame 2, a pair of spring terminals 3 and a speaker unit 4.

The frame 2 has a first cylindrical portion 21, an annular portion 22 perpendicular to a side wall of the first cylindrical portion 21 and extending from one peripheral edge portion of the first cylindrical portion 21, and a second cylindrical portion 23 perpendicular to one peripheral edge portion of the annular portion 22 and extending from the one peripheral edge portion of the annular portion 22, and these constituents are integrally molded.

The second cylindrical portion 23 is formed to have a larger diameter than that of the first cylindrical portion 21, and houses therein the speaker unit 4 which will be described later.

Flatness is ensured on a top surface of the annular portion 22. In the annular portion 22, a protruding portion 22a, a pair of holes 22b, and a pair of L-shaped hooked protruding portions 22c are formed. The pair of holes 22b are each formed into a rectangular shape, and each of them is symmetrical at both sides of the protruding portion 22a, namely, with respect to a center line L1 passing through a center O of the frame 2. The pair of L-shaped hooked protruding portions 22c protrude from the top surface of the annular portion 22, and they are symmetrical with respect to the center line L1 with the holes 22b between them. The pair of L-shaped hooked protruding portions 22c have catching portions 22ca which function as hooks.

The pair of spring terminals 3 each have a contact point portion 3a provided at one end, a support portion 3b for elastically supporting the contact point portion 3a, a mounting portion 3c formed by being extended from the support portion 3b and having flatness, a rectangular opening 3ca formed in approximately a center of the mounting portion 3c and an L-shaped insertion portion 3d provided at the other end and formed by being extended from the mounting portion 3c, and these constituents are integrally molded. As a material of the pair of spring terminals 3, for example, a material such as phosphor bronze or stainless may be used.

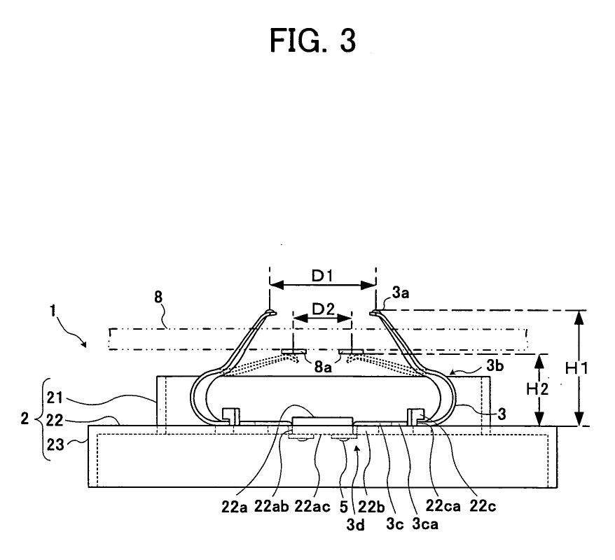

The contact point portion 3a contacts an external circuit, for example, a pattern 8a of a printed circuit board 8 which constitutes an information equipment as shown in FIG. 3. The support portion 3b has an arc-shaped portion in one part of the support portion 3b, and supports the contact point portion 3a movably in an up-and-down direction as the result that the arc-shaped portion is bent. An undersurface of the mounting portion 3c of the spring terminal 3 is adhered to the top surface of the annular portion 22 by an adhesive (not shown). The L-shaped hooked protruding portion 22c is inserted in the opening 3ca, and the catching portion 22ca thereof is engaged in an internal peripheral edge portion of the opening 3ca. The L-shaped insertion portion 3d is inserted into the hole 22b as shown in FIG. 1B. According to the above construction, the spring terminals 3 are mounted on the frame 2.

The speaker unit 4 is housed inside the second annular portion 22 as described above. The speaker unit 4 has a magnetic circuit portion 6, a diaphragm 4d and a support frame 4f which supports the diaphragm 4d with respect to the magnetic circuit portion 6, as shown in FIG. 2D.

The magnetic circuit portion 6 is constructed as an external magnet type magnetic circuit, and has a center pole 4a at a center portion, an annular magnet 4b disposed around a lower portion of this center pole 4a, and an annular plate 4c disposed to be overlaid on the lower portion of the magnet 4b. The speaker device according to this embodiment is not limited to the speaker unit having the above-described constituents, and is applicable to various kinds of speaker units such as an internal magnet type speaker unit, for example.

In the magnetic circuit portion 6, a magnetic circuit is constructed by the center pole 4a, the magnet 4b and the plate 4c, and the magnetic flux of the magnet 4b is concentrated in a magnetic gap 7 formed between an internal side end surface of the plate 4c and a tip end side outer peripheral surface of the center pole 4a.

The diaphragm 4d is formed as a semispherical dome-shaped diaphragm, and a voice coil 4e is attached to a base end side of the diaphragm 4d. The voice coil 4e is disposed in the magnetic gap 7 of the magnetic circuit portion 6. The lead wire (not shown) of this voice coil 4e is connected with an external connecting terminal, namely, the L-shaped insertion portion 3d of the spring terminal 3 by solder 5, as understood with reference to FIG. 1B and FIG. 2D. An edge portion 4da of the diaphragm 4d is supported by the support frame 4f.

In the speaker unit 4 constructed as described above, when an electric signal is inputted into a pair of contact point portions 3a of the spring terminal 3 through the pattern 8a of the printed circuit board 8 constituting the above-described information equipment, the electric signal is supplied to the voice coil 4e via the pair of L-shaped insertion portions 3d and the like. This generates a driving force of the voice coil 4e in the magnetic gap 7 to vibrate the diaphragm 4d in the axial direction of the speaker unit 4. In this manner, the speaker unit 4 generates sound in the direction of the arrow 10 in FIG. 1B.

As described above, the above-described speaker device 1 does not have a complicated construction in which a board to be connected to the spring terminal 3 is provided and they are mounted to the frame as in the conventional speaker device, but has a simple construction in which the spring terminal 3 is directly mounted on the frame 2. As a result, in the above-described speaker device 1, the manufacturing cost can be reduced by the amount of the board which is not provided. Therefore, the speaker device 1 can be made less expensive.

In the above-described speaker device 1, the one inner peripheral edge portion of the opening 3ca of the spring terminal 3 is engaged with the catching portion 22ca of the L-shaped hooked protruding portion 22c of the frame 2, and the L-shaped insertion portion 3d of the spring terminal 3 is inserted into the hole 22b of the frame 2, whereby the spring terminal 3 is fixed to the frame 2. Therefore, the spring terminal 3 can be reliably mounted on the frame 2 without fixing the spring terminal and the frame with a caulking pin or the like as in the conventional speaker device. In addition, the undersurface of the mounting portion 3c of the spring terminal 3 is adhered onto the top surface of the annular portion 22a of the frame 2 via the adhesive, and therefore the spring terminal 3 can be firmly fixed to the frame 2.

In the conventional speaker device in which the spring terminal and the frame are fixed by the caulking pin, the spring terminal and the frame are fixed by pressing and crushing the caulking pin after the spring terminal is mounted on the frame, and therefore it is necessary to ensure a predetermined space around the caulking pin. Therefore, a pair of contact point portions of the spring terminal cannot be disposed around the caulking pin, and hence a pair of contact point portions of the spring terminal cannot be positioned close to each other.

On the other hand, the above-described speaker device 1 does not have the construction in which the spring terminal and the frame are fixed by pressing and crushing the caulking pin or the like after the spring terminal is mounted on the frame as in the conventional speaker device, in other words, the spring terminal 3 is mounted on the frame 2 with the above-described construction, and therefore the contact point portions 3a of a pair of spring terminals 3 can be disposed at the positions close to each other, and at the positions on the outer peripheral edge portion of the frame 2, namely, at the positions above the top surface of the annular portion 22.

Here, FIG. 3 shows the state in which the contact point portions 3a of a pair of spring terminals 3 and the pattern 8a of the printed circuit board 8 are connected, as a side view.

At first, in the state in which a pair of connecting point portions 3a are not in contact with the pattern 8a of the printed circuit board 8, a distance between a pair of contact point portions 3a and the top surface of the annular portion 22 of the frame 2 is “H1”. A distance between the pair of contact point portions 3a is “D1”. From this state, the support portion 3b of the spring terminal 3 is bent to reduce the distance between the pair of contact point portions 3a and the top surface of the annular portion 22 to “H2” (<H1), and the pair of contact point portions 3a and the pattern 8a are connected by soldering. This makes the distance between the pair of contact point portions 3a “D2” (<D1). Therefore, according to the above-described speaker device 1, it is possible to cope with narrowing of the pitch of an external circuit, for example, the pattern 8a of the printed circuit board 8 constituting an information equipment.

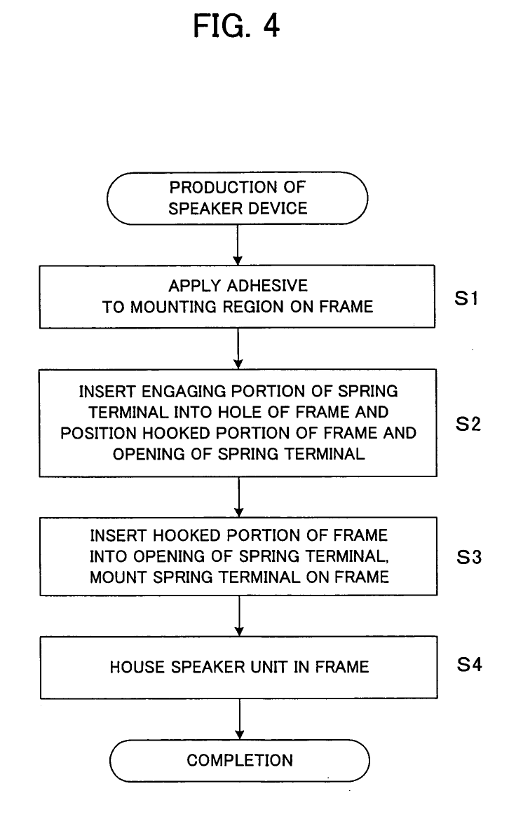

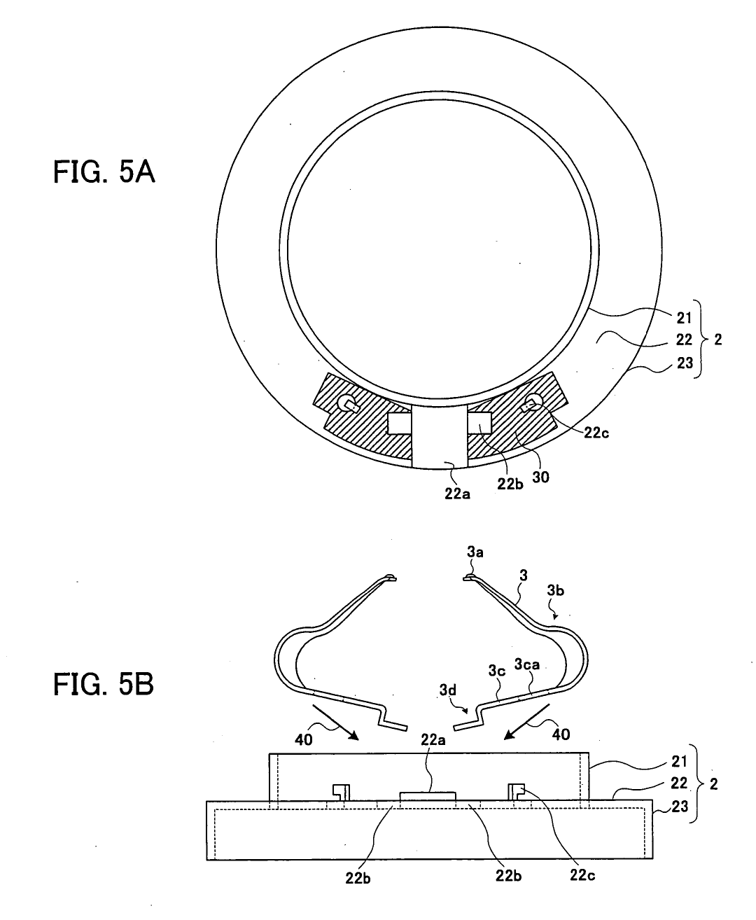

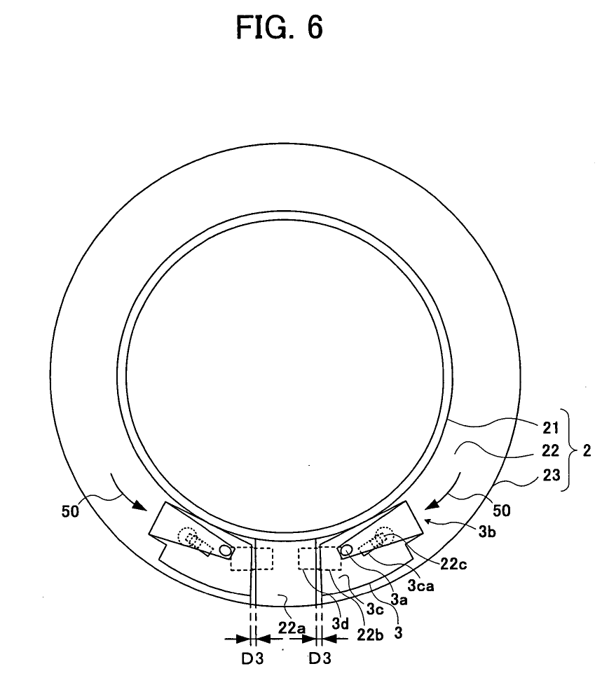

Next, a method of manufacturing the above-described speaker device 1 will be explained with reference to FIG. 4 to FIG. 6. FIG. 4 shows a flow chart of the method of manufacturing the speaker device 1. FIG. 5 and FIG. 6 show a plan view and a side view of the constituents of the speaker device 1 in each step.

First, the adhesive is applied to a mounting region on the frame 2 (step S1). More specifically, the adhesive is applied to the region in which the undersurface of the mounting portion 3c of the spring terminal 3 and the top surface of the annular portion 22 of the frame 2 overlay on each other, namely, a mounting region 30 (diagonally shaded portion) of the frame 2, as shown in the plan view in FIG. 5A. In this case, a method of applying the adhesive onto the undersurface of the mounting portion 3c of the spring terminal 3 can be considered, but the spring terminal 3 is an extremely small component, and therefore it is better to apply the adhesive to the mounting region 30 of the frame 2 as in this embodiment from the viewpoint of operability.

Next, the L-shaped insertion portions 3d of the spring terminals 3 are inserted into the holes 22b of the frame 2, and the L-shaped hooked protruding portions 22c of the frame 2 and the openings 3ca of the spring terminals 3 are positioned relative to each other (step S2). More specifically, as shown in the side view in FIG. 5B, the L-shaped insertion portions 3d of the spring terminal 3 are inserted into the holes 22b of the frame 2 from the diagonal directions shown by the arrows 40, and the spring terminals 3 are moved so that and the L-shaped hooked protruding portions 22c of the frame 2 can be inserted into the openings 3ca of the spring terminals 3. Thereby the L-shaped hooked protruding portions 22c of the frame 2 and the openings 3ca of the spring terminal 3 are relatively positioned.

Next, the spring terminals 3 are mounted on the frame 2 by inserting the L-shaped hooked protruding portions 22c of the frame 2 into the openings 3ca of the spring terminal 3 (step S3). More specifically, as understood with reference to FIG. 5B and the plan view in FIG. 6, first the L-shaped hooked protruding portions 22c of the frame 2 are inserted into the openings 3ca of the spring terminal 3 by moving the spring terminals 3 downward, and the undersurfaces of the mounting portions 3c of the spring terminals 3 are brought into contact with the top surface of the annular portion 22 of the frame 2. In this state, there is a gap of a predetermined distance D3 between the spring terminals 3 and each side wall of the protruding portion 22a of the frame 2.

Subsequently, as understood with reference to FIG. 1B and FIG. 6, while the spring terminals 3 are slid along approximately the circumferential direction of the frame 2, namely, the direction of the arrows 50 from this state, the one inner peripheral edge portions of the openings 3ca of the spring terminals 3 are engaged with the catching portions 22ca of the L-shaped hooked protruding portions 22c of the frame 2.

Next, the speaker unit 4 shown as the sectional view in FIG. 2D is housed inside the annular portion 22 of the frame 2 (step S4). In this case, the L-shaped insertion portions 3d of the spring terminals 3 and the lead wire of the voice coil 4e of the speaker unit 4 are connected by the solders 5, as understood with reference to FIG. 1B. In this manner, the speaker device 1 shown in FIGS. 1A and 1B is manufactured.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2003-370682 filed on Oct. 30, 2003 including the specification, claims, drawings and summary is incorporated herein by reference in its entirety.

1. A speaker device comprising a terminal electrically connected to an external circuit and a voice coil, and a frame for housing a speaker unit,
wherein said frame has a hooked protruding portion and a hole,
wherein said terminal has a contact point portion which is formed at one end and is in contact with said external circuit, an insertion portion formed at the other end, a mounting portion mounted to said frame, and an opening formed at said mounting portion; and
wherein said terminal is fixed to said frame by said insertion portion being inserted into said hole and said hooked protruding portion engaging in an inner peripheral edge portion of said opening.

2. The speaker device according to claim 1, wherein said terminal is mounted to said frame in an outer peripheral edge portion of said frame.

3. The speaker device according to claim 1, wherein a pair of said terminals are fixed to said frame, each of said contact point portions is disposed close to each other at a position on an outer peripheral edge of said frame.

4. The speaker device according to claim 1, wherein said mounting portion is adhered to said frame by an adhesive element.

5. A method of manufacturing a speaker device comprising a terminal electrically connected to an external circuit and a voice coil, and a frame for housing a speaker unit, comprising the step of fixing said terminal to said frame by inserting an insertion portion formed at said terminal into a hole formed in said frame and inserting a hooked protruding portion formed at said frame into an opening formed in said terminal, and by relatively sliding said terminal and said frame to engage an inner peripheral edge portion of said opening with said hooked protruding portion.
